(19) United States
(12) Patent Application Publication
(10) Pub. No.: US 2009/0031628 A1
(43) Pub. Date: Feb. 5, 2009

(54) PLANT TISSUE CULTURE DISPLAY BOX

(75) Inventor: Chih-Fei Lee, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: TAIKON CORP., Taipei (TW)

(21) Appl. No.: 11/831,322

(22) Filed: Jul. 31, 2007

(51) Int. Cl. A01G 9/02

(52) U.S. Cl. 47/66.6

(57) ABSTRACT

The present invention provides an easily storing, transporting and displaying plant tissue set, comprising a displaying shelf, and at least one plant-tissue-culturing tube, wherein the displaying shelf has concavities at the bottom or hollow designs to hold tubes. The displaying shelf is designed in a stairs shape which makes the bottom of every tube be irradiated by light, so plant tissues can be exposed to enough light. In addition, the whole package can be easily unfolded and refolded into a displaying mold. This present invention provides a way to displaying the growth process of plants, and it is educative and enjoyable.

### FIELD OF THE INVENTION

The present invention relates to a displaying set which is specific for placing plant-tissue-culturing tubes. This present invention is well-designed to exhibit, transport and store plant-tissue-culturing tubes.

### BACKGROUND

The technique of culturing plants had started in the beginning of 20^{th} century. Over 100 years, the technique has been well-established. Generally, a cultivator takes a part of plant tissue or even a single cell from a plant tissue, and then cultures it on a nitrogen rich medium along with growth nutrients. Different tissues have different differential abilities, and some plants can only be cultivated by specific tissues or organs. In addition, plant tissues should be cultured in a germ-free environment to avoid infections of bacteria or fungi.

Because of the progress of technology, plant-tissue-culturing technique is not limited to the laboratories. Nowadays, people can buy commercial plant-tissue-culturing tubes and then culture the plant tissues at home. However, proper containers for storing and transporting plant-tissue-culturing tubes are still unavailable in present markets; therefore, culturing tubes are usually stored and transported under the darkness in boxes. Moreover, when the plant-tissue-culturing tubes are displayed in the stores, they usually are placed in boxes which prevent buyers from seeing tubes directly. Therefore, buyers have to take tubes out of boxes if they want to see the tubes. Furthermore, plant tissues in the culturing tubes often grow poorly or even die due to the dark environment.

### SUMMARY OF THE INVENTION

A displaying and culturing set of plant tissues, comprising a display shelf and at least one plant-tissue-culturing tube, wherein the display shelf provides culturing tubes with sufficient light which makes plants in the tubes grow better.

In addition, the whole package, comprising a display shelf, culturing tubes and an outer case can be easily unfolded and refolded into a displaying mold.

### BRIEF DESCRIPTION OF THE DRAWINGS

FIG. 1 shows the structure of the present invention.

The illustration of the main component:

100: displaying shelf

110: the side board of the displaying shelf

120: the lid of plant-tissue-culturing tube

130: plant-tissue-culturing tube

140: the back board of the displaying shelf

150: the stair-shaped platform of the displaying shelf

FIG. 2 shows the entity of the plant tissue culturing tubes.

FIG. 3A and 3B shows the displaying and culturing set of plant tissues before and after taken apart the package are taken apart. FIG. 3A shows the cubical structure of the package before it is taken apart and culturing tubes are stored in the package. FIG. 3B shows the unfolded package which can be formed by refolding the outer casepackage of FIG. 3A.

### DETAILED DESCRIPTION OF THE INVENTION

The present invention is aimed to popularize the plant tissue culture and reduce the drawbacks of lacking lights when culturing a plant tissue in a tube. The present invention can not only display many plant-tissue-culturing tubes at a time, but also provide sufficient light for plant tissues. In addition, the present invention provides a well-designed displaying and storing case which can be unfolded and refolded easily into the displaying shape without excessive cutting and pasting; therefore, it is very convenient to display plant-tissue-culturing tubes.

The present invention relates to a displaying and culturing set of plant tissues, comprising a display shelf and at least one plant-tissue-culturing tube, wherein the display shelf is designed as stairs shape, wherein the height of a stair is higher than the height of a tube. This stair structure is suitable for displaying many plant-tissue-culturing tubes at one time and provides sufficient light to the plant tissues. Furthermore, the displaying shelf may have concavities or hollow design to hold the culturing tubes.

The present invention uses a cubical outer case for transportation and storage, but the shape of the outer case is not limited to cubic, and the material of the case can be paper or plastic. The displaying shelf is placed in the outer case, and the outer case can be easily unfolded and refolded to be the back board and side boards of the displaying shelf. In addition, the plant-tissue-culturing tubes are placed on the displaying shelf in advance, so they don't have to be arranged on the shelf after unfolding the outer case. Moreover, the back board or side boards of the displaying shelf can exhibit pictures or drawings of the plants in order to attract customers.

The displaying shelf and the outer case of the present invention can be made of any foldable materials especially paper or plastic.

The present invention comprises a lid on the top of a culturing tube, so the inside of the culturing tube is a germ-free environment. The bottom of the culturing tube is filled with medium which provides the plant tissue with nutrients. The plant tissues can be taken from any kinds of plants which are suitable to grow in the tubes, carnivorous plants, water plants, orchids or roses in particular. In addition, the culturing tubes of the present invention can be any shape, including toy figures, for the purpose of attracting customers. Moreover, the culturing tubes and lids can be labeled with plants' names or picture, and they can also be attached with chains which provide hanging function.

The present invention can create a green and fresh visual environment; therefore, it is enjoyable and educative. Moreover, it is beneficial for display, transportation and storage and increases the survival of plants.

### EXAMPLE

The following example is used to present the advantages of the present invention, but it does not limit the presentation of the present invention.

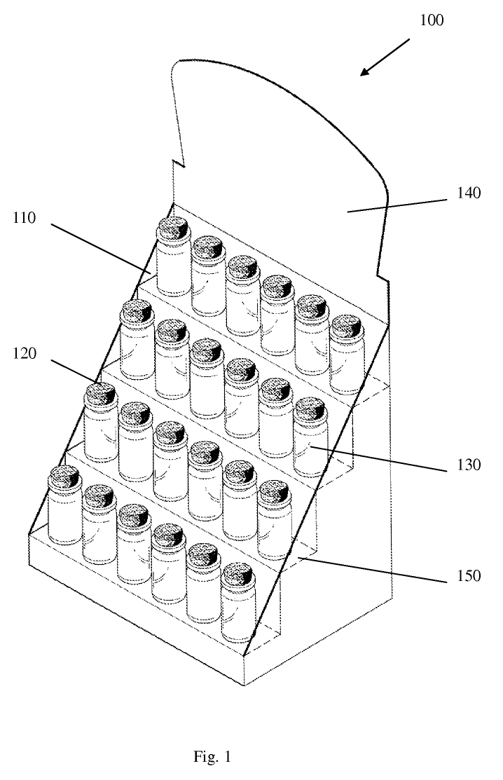

FIG. 1 shows the structure of the present invention. The main part of the present invention is composed of displaying shelf and culturing tubes. The concavities or holes are designed to place culturing tubes and the displaying shelf has stairs-shaped platforms for displaying many culturing tubes at a time. The stairs-shaped design of the displaying shelf allows light to irradiate the bottom of culturing tubes and prevents plant tissues from dying due to the lack of light.

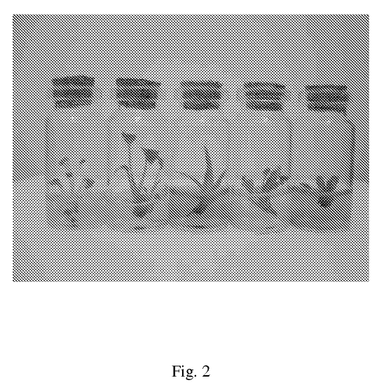

FIG. 2 shows the entity of the plant tissue culturing tubes. The inside of the tubes are germ-free and the media at the bottom of the culturing tubes provide plant tissues with sufficient nutrients and moisture so that the cultivators do not have to open the lids to refill water and nutrients. The chosen plants are any plants, such as carnivorous plants, water plants, orchids or roses, which are suitable for culturing in tubes. In addition, the culturing tubes can be any shape such as toy-shape or test tube shape. Moreover, the lids of culturing tubes can be attached with chains which make culturing tubes portable as accessories.

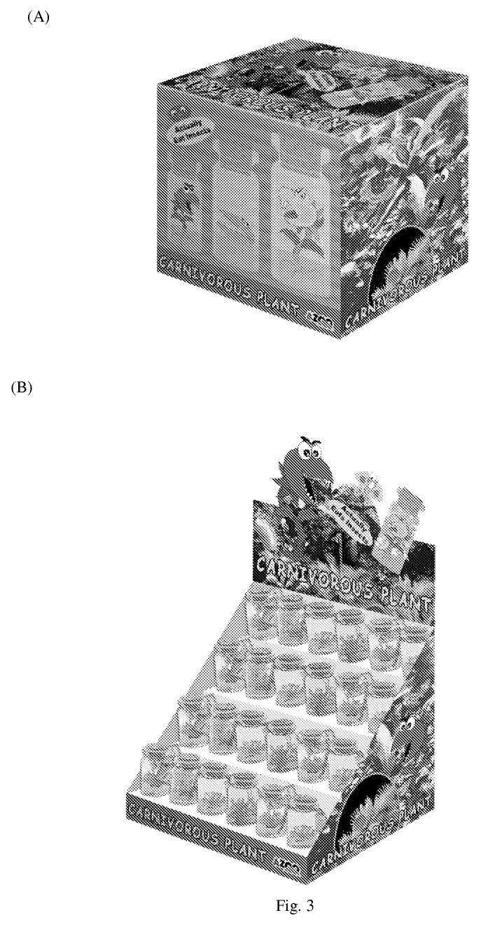

FIG. 3A shows the cubical shape of the displaying and culturing plant tissue set during transportation, and FIG. 3B shows the displaying shape of the set which is formed by unfolding the cubical case and followed by refold it into the displaying shape without excessive cut or paste. In addition, there's no need to place the culturing tubes on another shelf. Therefore, the present invention provides cultivators with convenient storage, transportation and display.

Furthermore, the present invention provides a back board and side boards which can be folded easily from the cubical case. Finally, these boards, culturing tubes and their lids can be painted or pasted with any kind of pictures and tags for better appearance to attract more customers.

What is claimed is:

1. A displaying and culturing set of plant tissues, comprising a display shelf and at least one plant-tissue-culturing tube, wherein the display shelf provides culturing tubes with sufficient light which makes plants in the tube grow better.

2. The displaying set of claim 1, wherein the culturing tube is composed of a lid and a diaphanous tube which has growth medium and a plant in it.

3. The displaying set of claim 1, wherein the display shelf has at least one concavity at the bottom to hold the culturing tube or has hollow layers to fix the culturing tube on the shelf.

4. The displaying set of claim 1, wherein the display shelf is made of paper of plastic.

5. The displaying set of claim 1, wherein the display shelf is in a stairs-shape.

6. The displaying set of claim 5, wherein the height of a stair of the displaying shelf is higher than that of the culturing tube.

7. The displaying set of claim 1, wherein the plant is suitable for living in the culturing tube.

8. The displaying set of claim 7, wherein the plants are carnivorous plants, water plants, orchids or roses.

9. The displaying set of claim 1, wherein the culturing tube can be labeled with pictures or tags.

10. The displaying set of claim 1, wherein the shape of the culturing tube can be any kind.

11. The displaying set of claim 10, wherein the shape of the culturing tube can be toy-shape, test tube shape or bottle shape.

12. The displaying set of claim 1, wherein the culturing tube can be added with a chain which makes the tube portable as accessory.

13. The displaying set of claim 1, wherein the displaying set is stored in a cubical case, and the case can be unfold and refold to become the back and side boards of the displaying shelf.

14. The displaying set of claim 13, wherein the cubical case is made of paper or plastic.

15. The displaying set of claim 13, wherein the back and side board of the display shelf can be painted or pasted with patterns of any kind.
